(19) United States
(12) Patent Application Publication
(10) Pub. No.: US 2004/0090340 A1
(43) Pub. Date: May 13, 2004

(54) Warning and guidance apparatus

(76) Inventors: Richard McLean, Hampton (AU); Gary Whelan, Stoney Creek (AU)

Correspondence Address: John C Kerins, Miles & Stockbridge, Suite 500, 1751 Pinnacle Drive, McLean, VA, 22102-3833, US

(21) Appl. No.: 10/311,758

(22) PCT Filed: Jun. 7, 2001
(86) PCT No.: PCT/AU01/00675

(30) Foreign Application Priority Data
Jun. 19, 2000 (AU) PQ 8209

(51) Int. Cl. G08B 3/00

(52) U.S. Cl. 340/691.1

(57) ABSTRACT

There is disclosed a warning and guidance apparatus for warning a person within a structure of a fire and assisting the person to navigate out of the structure, the warning and guidance system has guidance means (3) having a guide light (9) located within a structure near a floor level of said structure to provide a navigational aid when switched on, and fire alarm means (1) for detecting a fire and initiating an alarm (4) when a fire is detected to thereby warn a person of said fire, said fire alarm means also switching said guidance means (2) on when a fire is detected, whereafter said person can use said guide light (9) to navigate out of the structure.

### FIELD OF THE INVENTION

The present invention relates to warning and guidance apparatus for warning a person within a structure of a fire and assisting the person to navigate out of the structure. The invention relates particularly to warning and guidance apparatus for assisting a person or persons to escape from a house fire.

### BACKGROUND OF THE INVENTION

Household fires are unfortunately common events. Occupants are usually ill prepared for a fire which means that fires often end in the tragic death of one or more occupants of the house. To escape the fire, the occupant must first become aware of the fire and secondly must escape from their dwelling before they are overcome by the flames and/or the smoke. Indeed, it is often the smoke and/or fumes from a fire which result in the death of the occupants. An occupant, may be disoriented because of the smoke and/or a person may be overwhelmed by the lack of oxygen and collapse, and subsequently die from asphyxiation.

In recent years, the use of smoke detectors as fire alarms in private dwellings has become more and more frequent. Smoke detectors provide an early warning of the existence of a fire and give the occupants of the dwelling a greater chance to escape from the smoke and flames. There have also been a number of educational programs which encourage people to plan how to escape from a fire in their house and, in particular, emphasise the need for people to get down low below the smoke so that they are not asphyxiated when escaping. However, it is still common for people to panic when confronted by a fire. For example, a person may be woken in the middle of the night by a smoke detector in a room that is already partially filled with smoke. The person may panic and rush towards a door but may be disorientated because they have been asleep. In their panic, they may forget the need to get down low below the smoke and may not be able to find the doorway in their confusion or before they are overwhelmed.

### SUMMARY OF THE INVENTION

It is therefore the object of the present invention to provide warning and guidance apparatus to assist a person to make their way out of a structure such as a building.

The present invention provides warning and guidance apparatus for warning a person within a structure of a fire and assisting the person to navigate out of the structure, said warning and guidance system having:

guidance means having a guide light located within a structure near a floor level of said structure to provide a navigational aid when switched on, the guide light being associated with a power outlet located within said structure; and

fire alarm means for detecting a fire and initiating an alarm when a fire is detected to thereby warn a person of said fire, said fire alarm means also switching said guidance means on when a fire is detected, whereafter said person can use said guide light to navigate out of the structure.

Preferably, said guidance means includes a plurality of guide lights.

Preferably, each light includes indication means to indicate which direction the person should move in to navigate out of the structure.

Preferably, said indication means is an arrow illuminated by said light.

Alternatively, said lights are arrow-shaped to provide said indication means.

Preferably, said fire alarm means includes a radio frequency (RF) transmitter and said guidance means includes a RF receiver, said fire alarm mean switching said guidance means on by transmitting a turn-on signal to said RF receiver.

Preferably, there are a plurality of RF receivers coupled to respective ones of said plurality of lights to turn on their respective light when they receive a turn-on signal.

Preferably, said fire alarm means includes light selection means for selecting which lights of said guidance means should be turned on and controlling said RF transmitter to send turn-on signals to RF receivers of selected lights.

Preferably, each light is associated with a power outlet located within said structure.

Preferably, each light is part of a power outlet.

Alternatively, each light may be plugged into a power outlet.

Preferably, said fire alarm mean has a smoke detector for detecting said fire.

Preferably, said structure is a building.

The invention also provides a guidance device adapted to be plugged into a building and having:

a light; and

a receiver for receiving a turn-on signal from a fire alarm device, said receiver being coupled to said light to turn on said light upon receipt of said turn-on signal.

The invention further provides a fire alarm device having:

a fire detector; and

a transmitter, coupled to said fire detector, for transmitting a turn-on signal to a guidance device to thereby turn on said guidance device when said fire detector detects a fire.

An example of a preferred embodiment of the invention will now be described with reference to the accompanying drawings in which:

### BRIEF DESCRIPTION OF THE DRAWINGS

FIG. 1 is a schematic diagram showing the various elements of the present system;

FIG. 2 shows a power outlet, suitable for use with the present system; and

FIG. 3 shows a power outlet adaptor suitable for use with the present invention;

FIG. 4 shows an alternative power outlet; and

FIG. 5 shows an alternative power adaptor.

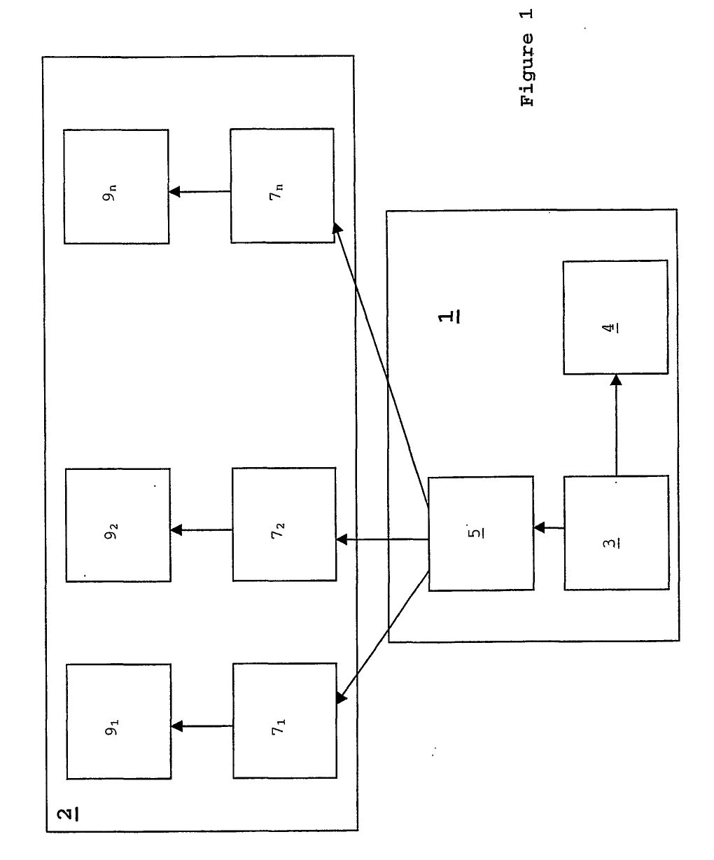

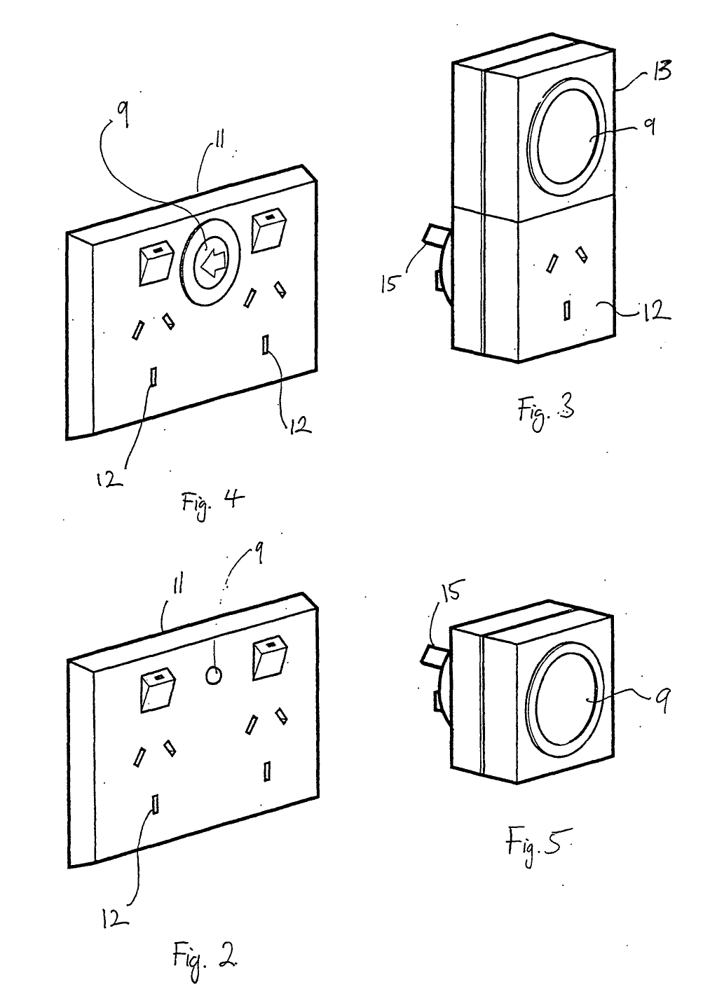

### DESCRIPTION OF THE PREFERRED EMBODIMENT

In the preferred embodiment, a warning and guidance system, for warning a person within a structure (such as a house or other dwelling) of a fire to assist the person to navigate out of the house, has a fire alarm means 1 for initiating an alarm 4 when a fire is detected by a smoke detector 3. The alarm 4 provides an audible alarm such as a loud high pitched sound to warn a person of the fire.

The fire alarm means also includes a radio frequency transmitter 5. When the smoke detector 3 detects a fire, a radio frequency transmitter 5 transmits a turn-on signal to the plurality of radio frequency receivers 7₁ to 7ₙ of the guidance means 2 to thereby turn-on the plurality of guide lights 9ᵢ to 9ₙ associated with respective ones of the receivers 7. The guide lights 9 are located near floor level so as to be in the clean air below the smoke so that they are visible when there is smoke in the house and also to encourage a person within the house to get down low to follow the lights.

The number of guide lights 9 used in the warning and guidance system will depend on factors such as the size of the dwelling and the number of exits. For example, in a small dwelling with a single room, the system may incorporate a single guide light 9 located near the exit to the room. In a larger house, guide lights may be provided in all rooms.

In the preferred embodiment, the guide lights are provided in a specially adapted power outlet 11 as shown in FIG. 2. In FIG. 2 the power outlet 11 incorporates two power sockets 12 and a guide light 9. This embodiment is preferred because power outlets 11 are typically located near to ground level. Further, this provides a convenient way to hard wire the guide lights 9 into the household electricity supply. This avoids, potential difficulties such as batteries which could be used to power the guide lights 9 being out of charge when there is a fire. Each receiver 7 is contained within the power outlet 11 and there is also provided a capacitive power storage device for powering the receiver and guide light in the event that a fire causes a power failure. A capacitive power storage device can also be associated with the fire alarm and transmitter. While less preferred, the guide lights and fire alarm may also be battery operated.

In an alternative embodiment shown in FIG. 2, guide lights 9 are provided in adaptor sockets 13, which can be plugged into a normal power outlet by way of pins 15 and provide a socket 12 which can be used as a power outlet. However, as illustrated in FIG. 5, a power outlet need not be provided. This embodiment is particularly suited for use with existing dwellings as it does not require any rewiring. It will be understood that the power outlets 11 and adaptor sockets 13 can be used in combination if this is appropriate.

The guide lights 9 may be provided with an indication means to indicate the direction the person should move in to navigate out of their house. As illustrated in FIG. 4, the indication means may be provided by, for example, a transparent sticker which may be located over the light and which incorporates an arrow which is illuminated by the light to indicate the direction which a person should proceed. Alternatively, an arrow may be provided close enough to the light 9 to ensure that it is illuminated by the light 9 and can be read by a person or the guide light 9 may be arrow-shaped.

In the preferred embodiment, all of the guide lights 9 are turned on when the smoke detector 3 detects a fire. Further, the system may incorporate a plurality of smoke detectors 3 each coupled to an individual transmitter 5 and any of the transmitters 5 may transmit a turn-on signal to the receiver 7.

In an alternative embodiment, the apparatus may incorporate a light selection means to selectively turn-on the lights of the guidance means 2. The light selection means may be used to direct persons away from the fire by not turning on lights which lead to the area in which the fire is located. For example, in a large dwelling a number of smoke detectors 3 may be used. Each of the smoke detectors 3 may be able to turn-on an alarm which is audible everywhere in the building. For example, audible warning devices may be associated with each light. The audible warning signal which is provided by the device is typically a loud high-pitched sound but may include the provision of voice commands to instruct persons to “get down low” and follow the lights or similar. The smoke detectors 3 which first detects the fire is likely to be nearest to the fire and therefore, the system may be configured so that it does not turn-on lights 9 which are closely located to the smoke detector which first detects the fire to thereby avoid a person heading into the area where the fire is located.

The apparatus includes a timer to turn-off the guide lights 9 after a fixed period of time, for example ten minutes, to thereby reset the apparatus. This is useful in situations where there is a false alarm as it avoids the need to manually reset the apparatus. However, a central reset button may be provided as part of the fire alarm means.

In the preferred embodiment, a smoke detector 3 has been employed in the fire alarm means to detect a fire. However, it will be apparent to a person skilled in the art of the invention that there are a number of other techniques for detecting a fire, such as infra-red techniques which detects the presence of a flame and that any appropriate technique can be used.

While the present invention finds particular application in houses, the invention can be adapted to other structures where people are likely to be at risk of fire, such as other buildings, boats, such as house boats, etc.

While transmission of an RF frequency signal between the smoke detector 3 and the receivers is preferred because this is unlikely to be disrupted by a fire, in other circumstances it may be appropriate to use other transmission means. For example, a turn-on signal could be transmitted over existing electrical wiring.

Further, the guide lights 9 may be located near the floor by being located on the floor. The lights may be configured to flash to make them easier to locate. The lights 9 may also be colour coded. In one embodiment, a liquid crystal display LCD may be used. The LCD display may include an arrow indicating the way out as well as stating the room in which the light is located—i.e. “Master bedroom”. The LCD may be programmable.

These and other modifications will be apparent to a person skilled in the art and should be considered as falling within the scope of the invention described herein.

The claims defining the invention are as follows:

1. Warning and guidance apparatus for warning a person within a structure of a fire and assisting the person to navigate out of the structure, said warning and guidance system having:
guidance means having a guide light located within a structure near a floor level of said structure to provide a navigational aid when switched on, the guide light being associated with a power outlet located within said structure; and
fire alarm means for detecting a fire and initiating an alarm when a fire is detected to thereby warn a person of said fire, said fire alarm means also switching said guidance means on when a fire is detected, whereafter said person can use said guide-light to navigate-out of the structure.

2. Warning and guidance apparatus as claimed in claim 1, wherein said guide light includes indication means to indicate which direction the person should move in to navigate out of the structure.

3. Warning and guidance apparatus as claimed in claim 2, wherein said indication means is an arrow illuminated by said light.

4. Warning and guidance apparatus as claimed in claim 2, wherein said guide light is arrow-shaped to provide said indication means.

5. Warning and guidance apparatus as claimed in any one of claims 1 to 4, said fire alarm means includes a radio frequency (RF) transmitter and said guidance means includes a RF receiver, said fire alarm means switching said guidance means on by transmitting a turn-on signal to said RF receiver.

6. Warning and guidance apparatus as claimed in claim 5, wherein said guidance means includes a plurality of guide lights.

7. Warning and guidance apparatus as claimed in claim 6, wherein there are a plurality of RF receivers coupled to respective ones of said plurality of lights to turn on their respective light when they receive a turn-on signal.

8. Warning and guidance apparatus as claimed in claim 6, wherein said fire alarm means includes light selection means for selecting which lights of said guidance means are turned on and controlling said RF transmitter to send turn-on signals to RF receivers of selected lights.

9. Warning and guidance apparatus as claimed in claim 6, wherein each light is associated with a power outlet located within said structure.

10. Warning and guidance apparatus as claimed in claim 9, wherein each light is part of a power outlet.

11. Warning and guidance apparatus as claimed in claim 9, wherein each light may be plugged into a power outlet.

12. Warning and guidance apparatus as claimed in claim 1, wherein said guidance means is coupled to a capacitive storage device for storing power from said power outlet in order to power said guidance means during a power failure.

13. Warning and guidance apparatus as claimed in any one of claims 1 to 12, said fire alarm mean has a smoke detector for detecting said fire.

14. Warning and guidance apparatus as claimed in any one of claims 1 to 13, wherein said structure is a building.

15. Warning and guidance apparatus as claimed in claim 7, wherein said guidance means and said fire alarm means are battery operated.

16. A guidance device adapted to be plugged into a power outlet and having:
a guide light; and
a receiver for receiving a turn-on signal from a fire alarm device, said receiver being coupled to said light to turn on said light upon receipt of said turn-on signal.

17. A guidance device as claimed in claim 16, wherein said receiver is a radio frequency receiver and said turn-on signal is a radio frequency signal.

18. A guidance device as claimed in claim 16 or claim 17, wherein said guide light includes indication means to indicate which direction a person should move in when said guide light is turned on.

19. A guidance device as claimed in claim 16, wherein said indication means is an arrow illuminated by said light.

20. A guidance device as claimed in claim 18, wherein said guide light is arrow-shaped to thereby provide said indication means.

21. A fire alarm device having:
a fire detector; and
a transmitter, coupled to said fire detector, for transmitting a turn-on signal directly to a guidance device to thereby turn on said guidance device when said fire detector detects a fire.
